(19) United States
(12) Patent Application Publication
(10) Pub. No.: US 2006/0200674 A1
(43) Pub. Date: Sep. 7, 2006

(54) METHOD FOR SECURING RFID CHARGE VALUE MEDIA VIA CRYPTOGRAPHIC SIGNING AND BLOCK LOCKING

(75) Inventors: Gregg Welker, Simi Valley, CA (US); Charles E. Wilson, Simi Valley, CA (US)

Correspondence Address: KELLY LOWRY & KELLEY, LLP, 6320 CANOGA AVENUE, SUITE 1650, WOODLAND HILLS, CA, 91367, US

(73) Assignee: PRECISION DYNAMICS CORPORATION, San Fernando, CA (US)

(21) Appl. No.: 11/307,182

(22) Filed: Jan. 26, 2006

Related U.S. Application Data
(60) Provisional application No. 60/647,744, filed on Jan. 26, 2005.

(51) Int. Cl. H04L 9/00

(52) U.S. Cl. 713/176

(57) ABSTRACT

A process for securely tracking debit transactions on an RFID charge media by encoding RFID charge media with an initial charge value, securing the RFID charge media with a cryptographic signature using a private key and a unique ID, verifying the cryptographic signature using a public key paired to the private key, and writing and locking a debit transaction record block on the RFID charge media. The RFID charge media is encoded and secured by reading the RFID charge media with a unique ID, encoding and writing an initial data set containing the initial charge value and a unique ID copy, and securing the RFID charge media using the cryptographic signature. The cryptographic signature is verified using a public key on the unique ID copy. The initial charge value and all locked debit transaction record blocks are used to calculate a current charge value.

### BACKGROUND OF THE INVENTION

This invention relates to radio frequency identification (RFID), and other transportable electronic data storage-and-transfer media with read-write capabilities. More particularly, the present invention concerns RFID as it relates to the field of charge value transactions, where the media is used to store units of worth that can be changed through transactions such as credit or debit. Because these units possess value, security issues are addressed by this invention through its use of cryptographic techniques to verify the authenticity of data entered or recorded to the media and by block locking. Using public/private keys—aka asymmetric encryption—this invention provides reinforced security on two complementary levels: by using mathematical techniques to create a verifiable “signature” and by locking specific sections of data contained in or on the media, but not locking the entire media.

There are many issues involved in securing electronic monetary transactions. Prior approaches typically utilized symmetric key encryption systems that required all charge media encoders and readers to have a common cryptographic key. Theft or otherwise unauthorized use of this key (via reader theft or other method) allowed the creation of duplicate and seemingly authentic charge media, which was in fact falsified.

Public/private key cryptographic techniques (asymmetric encryption) allowed readers to only possess the public or non-secret key, so authentication of valid charge media was possible, but the readers were then unable to change the values on the media securely, without the use of the original private (secret) key, and therefore increasing the risk of the system being compromised by loss or theft of the private key.

Systems with access to secure network communications at all reader stations may solve this problem by requesting that private encryption operations be performed by a remote server which possesses the private key. While solving the immediate problem of requiring the private key at each reader, it introduces another problem of authenticating valid readers and preventing unauthorized requests to the remote server for use of private key operations.

These solutions can only be used in situations where readers are securely and persistently connected to a network or have another secure communications to back-end servers possessing the private key.

Accordingly, there is a need for a secure method of encoding RFID media with a charge value (points or currency) and allow subsequent secure debit transactions to be recorded on the same media. There is also a need for preventing media duplication and detection of unauthorized modification via cryptographic signing techniques. There is an additional need for a method that allows standalone debit readers (no network or back-end database connection required) to verify authentic charge value media and debit against the RFID media without exposing the underlying cryptographic key (private/secret key) required for the creation of valid charge media encodings. There is a further need for substantially minimizing charge RFID media fraud via stolen debit reader stations and providing media-based debit transaction recording that negates the need for a constant network or server database connection. The present invention fulfills these needs and provides other related advantages.

### SUMMARY OF THE INVENTION

The present invention provides a secure method of encoding RFID media with a charge value (points or currency) and allows subsequent secure debit transactions to be recorded on the same media. The present invention prevents media duplication and detection of unauthorized modification via cryptographic signing techniques.

The process for securely tracking debit transactions on an RFID charge media, involving the steps of: encoding the RFID charge media with an initial charge value; securing the RFID charge media by creating a cryptographic signature using a private key and a unique ID from the RFID charge media; presenting the RFID charge media; verifying the cryptographic signature on the RFID charge media using a public key paired to the private key; and writing and locking a debit transaction record block on the RFID charge media.

The steps of encoding and securing the RFID charge media further include the steps of: reading the RFID charge media to determine that there are no locked debit transaction blocks on the RFID charge media; and retrieving the unique ID from the RFID charge media. The method further involves the steps of: encoding an initial data set containing the initial charge value and a unique ID copy; and writing the initial data set to the RFID charge media. The RFID charge media is secured using the cryptographic signature.

The RFID charge media is verified by reading the cryptographic signature from the RFID charge media, and verifying the cryptographic signature using the public key. The method further involves reading an initial data set containing the initial charge value and a unique ID copy from the RFID charge media. All locked debit transaction record blocks are read and confirmed and a current charge value remaining on the RFID charge media is calculated. The writing and locking step is performed only if the current charge value remaining on the RFID charge media is in a sufficient amount to cover a requested debit amount.

The private key and public key comprise RSA keypairs. The encoding and securing steps are performed at an RFID charging station. The verifying, writing and locking steps are performed at an RFID reader station. The RFID reader station is stand alone and not connected to a network or centralized server.

Other features and advantages of the present invention will become apparent from the following more detailed description, taken in connection with the accompanying drawings which illustrate, by way of example, the principals of the present invention.

### BRIEF DESCRIPTION OF THE DRAWINGS

The accompanying drawings illustrate the invention. In such drawings:

FIG. 1 illustrates an initial charge value method;

FIG. 2 illustrates a debit method; and

FIG. 3 illustrates an example of the method of operation.

### DETAILED DESCRIPTION OF THE PREFERRED EMBODIMENT

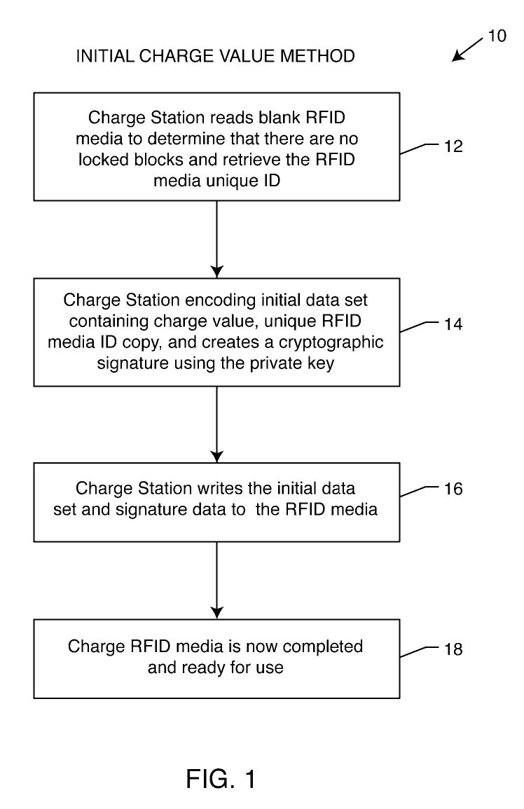

The present invention resides in a method for securing RFID charge value media via cryptographic signing and block locking. As illustrated in FIGS. 1-3, this method involves the combination of two components: (1) a public/private RSA key pair used for cryptographic signing of the RFID Charge media contents; and (2) an RFID media block locking facility to unalterably debit the media. The combination of the public-private key signing with unique media identifiers (and data set copies) along with debit transaction locking (permanent for ISO-15693 qualified devices) present a charge/debit support media format which reduces or eliminates the need for centralized or constant network server access to secure and validate debit transactions.

With respect to the first component (FIG. 1) (i.e., the public/private RSA key pair used for cryptographic signing of RFID Charge media contents), secured “charging” stations which have knowledge of the private (secret) key are used to initially create and sign initial RFID charge media balance values and data 10. Integral to this signing is the incorporation of the media's unique Tag Identifier (TID). A Charge Station reads blank RFID media to determine that there are no locked blocks and retrieves the RFID media unique ID 12. The Charge Station encodes the initial data set containing charge value, unique RFID media ID copy, and creates a cryptographic signature using the private key 14. The Charge Station writes the initial data set and signature data to the RFID media 16. The Charge RFID media is now completed and ready for use 18.

If the charge value related data contents of the RFID media are altered in any way (e.g. through duplication onto a second RFID media, or direct manipulation of the RFID data blocks themselves by an unauthorized third party with access to an RFID reader/writer) the cryptographic signature verification operation will fail. This signature verification operation requires only knowledge of the public (non-secret) key. Therefore obtaining access to a standalone reader does not provide the capability of creating or increasing the authorized charge value assigned to the RFID media.

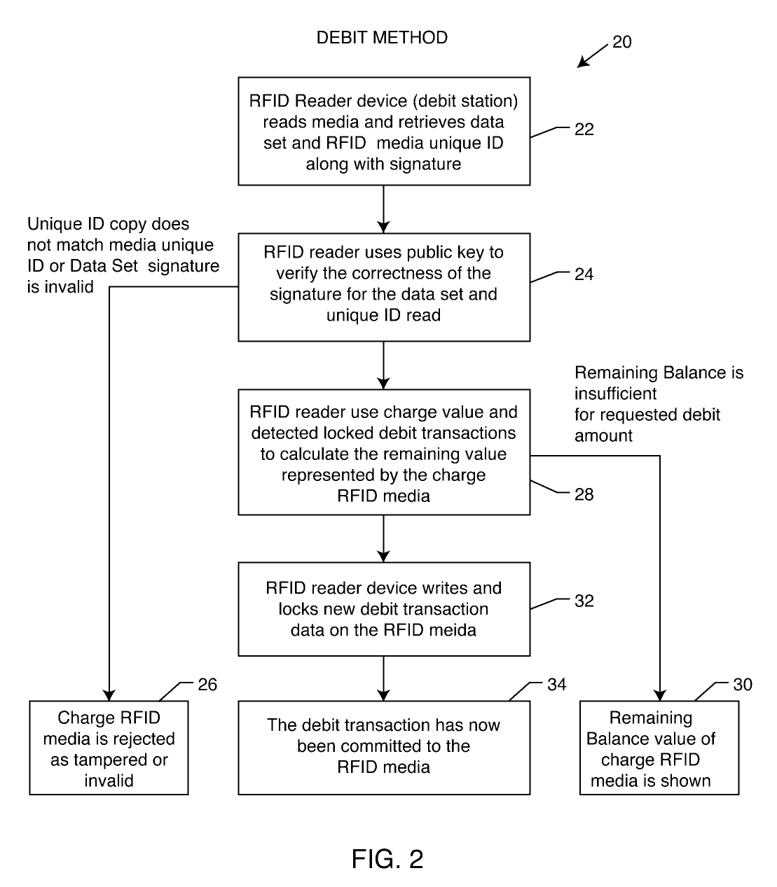

The second component of the method (FIG. 2) utilizes the RFID media block locking facility to unalterably debit the media 20. The standalone debit stations (i.e., the RFID Reader devices) read and confirm via the first component technique the current positive charge value of the RFID media. The reader stations then walk through any existing debit transactions recorded and locked on the RFID media blocks, and calculate the ending balance value remaining on the RFID media. No cryptographic resigning is required of the standalone reader stations since all transactions are restricted to debits only. Debit transactions cannot be erased or overwritten to falsely restore RFID charge value, since they are unalterably locked via the RFID media lock block operation.

In operation, the RFID Reader device (i.e., debit station) reads RFID media and retrieves data set and RFID media unique ID along with signature 22. The RFID reader uses the public key to verify the correctness of the signature for the data set and unique ID read 22. If the unique ID copy does not match the media unique ID or if the Data Set signature is invalid, then the Charge RFID media is rejected as tampered or invalid 26. Otherwise, the RFID reader uses charge value and any detected locked debit transactions to calculate the remaining value represented by the charge RFID media 28. If the Remaining Balance is insufficient for the requested debit amount, the Remaining Balance value of the Charge RFID media is shown 30. Otherwise, the RFID reader device writes and locks the new debit transaction data on the RFID media 32. The Debit transaction has now been committed to the RFID media 34.

Fraud exposure of the system is limited to the security of the charging stations only (should be viewed with same physical security requirements as a cash drawer system), and not effected by the number or exposure of debit stations. If a system compromise is detected (e.g. via theft or unauthorized access to charging stations containing the private (secret) key), a new key pair may be created, and installation of the new public (non-secret) key on standalone debit stations will resecure the system, invalidating any previous compromised RFID charge media.

The present invention is primarily described with banded RFID appliances (e.g., wristbands, ankle bands, etc), but is intended for use with all electronic media-carrying appliances, such as tags, labels, fobs, cards, and the like. In one embodiment, the RFID media device is appended to the identified person via a secured attachment device (e.g., snap or adhesive) that provides tamper-resistant and tamper-evident characteristics to ensure the security integrity of the carried appliance.

The method can be modified to apply to any media that provides permanent locking characteristics for read/write non-volatile data segments and sufficient storage for the desired data set supporting the charge/debit transaction environment.

This indicates that the method can be used for physical token granting and debit or loyalty point systems based on media other than RFID (i.e., the key innovations of the present invention can and should be adapted to any electronic media where read/write capabilities prevent an opportunity for breach of security via modification and/or media duplication).

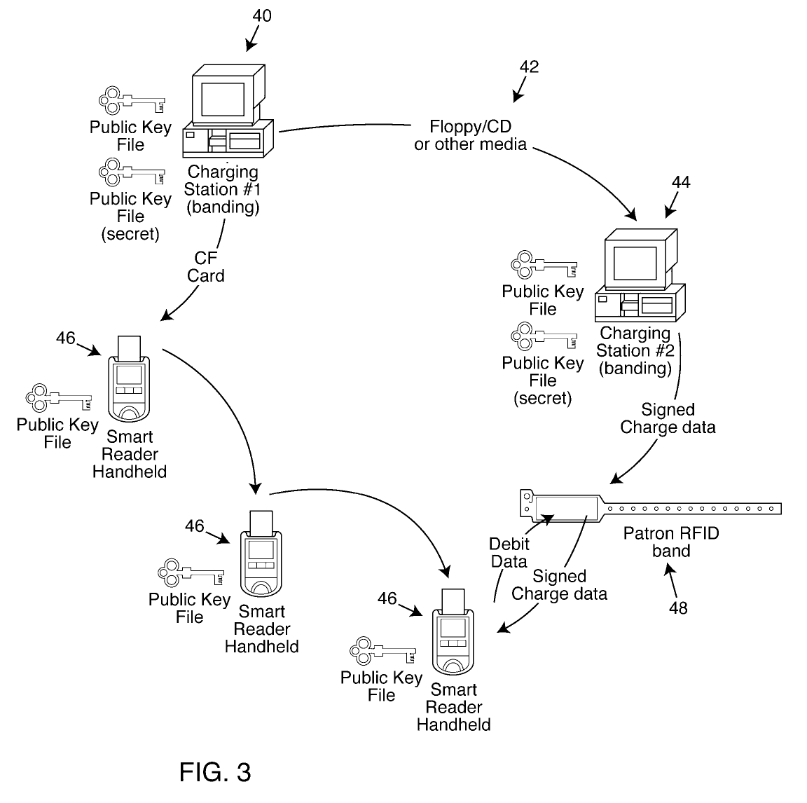

In use, the method operates as seen in FIG. 3 with a patron arriving at a venue with cash (e.g., currency, coin, traveler's check) or credit (e.g., credit card) in hand. The patron purchases an RFID media from an authorized Charge Station operator who then encodes the RFID media with value and purchase information, and cryptographically signs a data subset using a private key. The operator may provide a paper receipt (from the cash register or credit POS system) if the customer requests it.

The patron then visits a vendor within the venue and presents their RFID media (i.e., wristband) to pay for a product or service (e.g. popcorn, or entry into a show). Using an RFID reader device, the vendor reads the data contained within the RFID media. The RFID reader device confirms that the data subset contained on the media and the cryptographic signature also contained on the RFID media verifies against the public key possessed by the reader.

If the value remaining on the RFID media is sufficient for the desired debit action to be performed, the vendor initiates a debit operation using the RFID reader device. The RFID reader device writes and locks a transaction record block using the RFID media standard ISO-15693 locking commands to permanently record the debit transaction onto the media.

The patron may then visit another vendor within the venue and presents their RFID media for a desired balance check or debit operation. The vendor again uses an RFID reader device to read the data subset contained on the RFID media, and additionally to read any locked debit transaction blocks detected on the media. A remaining charge value balance is obtained by taking the original signed charge value (contained within the data subset) and subtracting any debit transactions found.

During all of these operations (except on the initial charging of a blank RFID device), the unique identifier of the RFID media is confirmed unchanged by comparing it to the unique RFID media ID (as specified by data contained within the data subset). This prevents unauthorized duplication of authentic charge value data contained on RFID media.

As shown in FIG. 3, the public and private keys may be created locally on a single Charging Station by a Key Generation utility 40. The venue can then install the public and private keys on additional Charging Stations 44 via floppy disc/CD or other media 42. The venue must then install the public key on each RFID reader device 46 intended for use in debiting operations against valid charge value RFID media 48.

Every RFID media 48 when charged is signed by the Charging Station(s) with the private key. When accessing, each RFID reader device responsible for debiting or balance checking verifies the signed charge balance of an RFID media by verifying the cryptographic signing of the data subset obtained from the media by using the public key previously distributed.

Distribution of the private and public keys may be a one time event for each venue, unless compromise of the private key dictates that a new key pair be generated and distributed.

The innovations of the present invention can and should be adapted to any usage where secured usage of its transaction records is necessary. Thus, the present invention can be adapted for use with hospital records, blood tracking, criminal incarceration ID, security ID (e.g., travel, military base access or the like) and is not to be limited to monetary transactions such as those described in detail above.

Although an embodiment has been described in detail for purposes of illustration, various modifications may be made without departing from the scope and spirit of the invention.

What is claimed is:

1. A process for securely tracking debit transactions on an RFID charge media, comprising the steps of:
encoding the RFID charge media with an initial charge value;
securing the RFID charge media by creating a cryptographic signature using a private key and a unique ID from the RFID charge media;
presenting the RFID charge media;
verifying the cryptographic signature on the RFID charge media using a public key paired to the private key; and
writing and locking a debit transaction record block on the RFID charge media.

2. The process of claim 1, wherein the private key and public key comprise RSA keypairs.

3. The process of claim 1, wherein the encoding and securing steps are performed at an RFID charging station.

4. The process of claim 1, wherein the verifying, writing and locking steps are performed at an RFID reader station.

5. The process of claim 1, wherein the steps of encoding and securing the RFID charge media further comprise the steps of:
reading the RFID charge media to determine that there are no locked debit transaction blocks on the RFID charge media; and
retrieving the unique ID from the RFID charge media.

6. The process of claim 5, further comprising the steps of:
encoding an initial data set containing the initial charge value and a unique ID copy; and
writing the initial data set to the RFID charge media.

7. The process of claim 6, further comprising the step of securing the RFID charge media using the cryptographic signature.

8. The process of claim 1, wherein the step of verifying the RFID charge media comprises the steps of:
reading the cryptographic signature from the RFID charge media; and
verifying the cryptographic signature using the public key.

9. The process of claim 8, further comprising the steps of:
reading an initial data set containing the initial charge value and a unique ID copy from the RFID charge media;
reading and confirming all locked debit transaction record blocks on the RFID charge media; and
calculating a current charge value remaining on the RFID charge media.

10. The process of claim 9, wherein the writing and locking step is performed only if the current charge value remaining on the RFID charge media is in a sufficient amount to cover a requested debit amount.

11. The process of claim 4, wherein the RFID reader station is stand alone and not connected to a network or centralized server.

12. A process for securely tracking debit transactions on an RFID charge media, comprising the steps of:
reading the RFID charge media to determine that there are no locked debit transaction blocks on the RFID charge media;
retrieving a unique ID from the RFID charge media;
encoding an initial data set containing an initial charge value and a unique ID copy;
writing the initial data set to the RFID charge media;
securing the RFID charge media by creating a cryptographic signature using a private key and a unique ID from the RFID charge media;
presenting the RFID charge media;
reading the cryptographic signature from the RFID charge media;
verifying the cryptographic signature on the RFID charge media using a public key paired to the private key; and
writing and locking a debit transaction record block on the RFID charge media.

13. The process of claim 12, wherein the private key and public key comprise RSA keypairs.

14. The process of claim 12, wherein the encoding and securing steps are performed at an RFID charging station.

15. The process of claim 12, wherein the writing and locking steps are performed at an RFID reader station.

16. The process of claim 12, further comprising the steps of:
reading the initial data set containing the initial charge value and the unique ID copy from the RFID charge media;
reading and confirming all locked debit transaction record blocks on the RFID charge media; and
calculating a current charge value remaining on the RFID charge media.

17. The process of claim 16, wherein the writing and locking step is performed only if the current charge value remaining on the RFID charge media is in a sufficient amount to cover a requested debit amount.

18. The process of claim 15, wherein the RFID reader station is stand alone and not connected to a network or centralized server.

19. A process for securely tracking debit transactions on an RFID charge media, comprising the steps of:
reading the RFID charge media to determine that there are no locked debit transaction blocks on the RFID charge media;
retrieving a unique ID from the RFID charge media;
encoding an initial data set containing an initial charge value and a unique ID copy;
writing the initial data set to the RFID charge media;
securing the RFID charge media by creating a cryptographic signature using a private key and a unique ID from the RFID charge media;
presenting the RFID charge media;
reading the cryptographic signature from the RFID charge media;
verifying the cryptographic signature on the RFID charge media using a public key paired to the private key; and
reading the initial data set containing the initial charge value and the unique ID copy from the RFID charge media;
reading and confirming all locked debit transaction record blocks on the RFID charge media;
calculating a current charge value remaining on the RFID charge media; and
writing and locking a debit transaction record block on the RFID charge media.

20. The process of claim 19, wherein the private key and public key comprise RSA keypairs.

21. The process of claim 19, wherein the encoding and securing steps are performed at an RFID charging station.

22. The process of claim 19, wherein the writing and locking steps are performed at an RFID reader station.

23. The process of claim 19, wherein the writing and locking step is performed only if the current charge value remaining on the RFID charge media is in a sufficient amount to cover a requested debit amount.

24. The process of claim 22, wherein the RFID reader station is stand alone and not connected to a network or centralized server.
